(19) United States
(12) Patent Application Publication
(10) Pub. No.: US 2019/0362272 A1
(43) Pub. Date: Nov. 28, 2019

(54) TRANSPORTATION SERVICE SYSTEM

(71) Applicant: TOYOTA JIDOSHA KABUSHIKI KAISHA, Toyota-shi (JP)

(72) Inventor: Mami KATO, Toyota-shi (JP)

(73) Assignee: TOYOTA JIDOSHA KABUSHIKI KAISHA, Toyota-shi (JP)

(21) Appl. No.: 16/401,258

(22) Filed: May 2, 2019

(30) Foreign Application Priority Data
May 24, 2018 (JP) 2018-099438

(51) Int. Cl. G06Q 10/02; G06Q 30/06; G06Q 50/30; G08G 1/00; G07C 5/00

(52) U.S. Cl. CPC G06Q 10/02; G06Q 30/0645; G07C 5/008; G08G 1/205; G06Q 50/30

(57) ABSTRACT

A vehicle manager transmits vehicle providing information including a time in which a vehicle owned by him/her is not used to a service management server of a service provider. A registered driver transmits driver providing information including his/her free time to the service management server. A client transmits service request information including a desired time frame for the transportation to the service management server. The service management server extracts a vehicle and a driver that meet the transportation service request in the service request information, and transmits the extracted information to the client. When the client accepts the information, the client transmits an order so that the vehicle manager and the registered driver confirm it. Thus, a contract for the transportation service is concluded. In this way, it is possible to effectively utilize idle resources such as vehicles and human resources.

### CROSS-REFERENCE TO RELATED APPLICATIONS

The present application claims priority under 35 U.S.C. § 119(a) to Japanese Patent Application No. 2018-99438, filed on May 24, 2018. The contents of this application are incorporated herein by reference in its entirety.

### TECHNICAL FIELDS

The present invention relates to a system in which a transportation service using an automobile (hereinafter also referred to as a “vehicle”) is provided. In particular, the present invention relates to improvement of a system in which a vehicle and a driver are provided according to a request of transportation service.

### BACKGROUND ART

In a modern society where the population is aging fast, it is desired to establish a social system for supporting transportation (for example, transportation to and from the hospital) of elderly people who do not have an automobile or have voluntarily returned their driver's license. In general, they use public transportation such as bus services or train services. However, moving to or from a bus stop or a station imposes a heavy burden on them.

Patent Document 1, which was made in consideration of the above problem, discloses that a plurality of members who hold membership share a riding-together vehicle with a driver. More specifically, a member who intends to receive a transportation service uses his/her portable information terminal (smartphone) to transmit a request for vehicle allocation to a service provider for. The service provider that has received the vehicle allocation request grasps an operating situation of each riding-together vehicle with a driver and transmits information on a scheduled arrival time of the vehicle and the like to the member. Thus, it is possible to provide the transportation service between the member's home and his/her destination using a riding-together vehicle, thereby improving convenience for the elderly people.

### PRIOR ART DOCUMENT

### Patent Document

[Patent Document 1] JP 2016-162438 A

### SUMMARY OF THE INVENTION

### Problem to Be Solved by the Invention

However, in the transportation service system disclosed in Patent Document 1, the vehicle to be used is a riding-together vehicle with a driver. That is, the vehicle as well as the driver belong exclusively to this system. For this reason, if only a small number of members use the system, the operating time of the vehicle and the driver is considerably reduced, which may prevent not only effective utilization of resources (vehicles and human resources) but also continuous maintenance of the system due to increased costs.

The inventor of the present invention notes that it is necessary to improve a method for procuring the resources (vehicles and human resources) in order to effectively utilize the resources and to continuously maintain the system, and for this purpose, the present invention was made.

The present invention was made in consideration of the above circumstances, an object of which is to provide a transportation service system capable of improving effective utilization of resources and continuously maintaining the system.

### Means for Solving the Problem

In order to achieve the above object, the present invention provides a transportation service system for providing a vehicle and a driver according to a transportation service request from a client. The transportation service system includes: a vehicle information acquisition unit configured to acquire, at least, time information available for the transportation service and vehicle location information in a time frame available for the transportation service, both as vehicle providing information on each of a plurality of vehicles registered in advance for providing the transportation service; a driver information acquisition unit configured to acquire, at least, time information available for driving for the transportation service and driver location information in a time frame available for driving for the transportation service, both as driver providing information on each of a plurality of drivers registered in advance for providing the transportation service; a client information acquisition unit configured to acquire, at least, time information desired for utilizing the transportation service and client location information when the transportation service is utilized, both as service request information from the client; a providing service extraction unit configured to extract a vehicle and a driver that meet the transportation service request in the service request information based on the respective kinds of information acquired by the vehicle information acquisition unit, the driver information acquisition unit and the client information acquisition unit; and a transmission unit configured to transmit information extracted by the providing service extraction unit to: the client; a vehicle manager of the extracted vehicle; and the extracted driver.

In the vehicle providing information here, the “time information available for the transportation service” means information on a time frame in which a vehicle is not used for its original purposes (for example, delivery services for the vehicle that is registered in advance by a home delivery company) or a time frame in which the vehicle is not scheduled to be used (time in which the vehicle is not used). Also, the “vehicle location information” means information on a parking lot where the vehicle is stored (parked) in the time frame available for the transportation service. In the driver providing information here, the “time information available for driving for the transportation service” means information on an available time frame for providing the driver (a person who has registered in advance as a driver) (i.e. a time frame in which the driver has no personal business, in brief, his/her free time). Also, the “driver location information” means information on the location of the driver in the available time frame for providing the driving for the transportation service. In the service request information here, the “time information desired for utilizing the transportation service” means information on a time frame in which the client desires to utilize the transportation service. Also, the “client location information” is information on the location of the client when the client receives the transportation service. Furthermore, “a vehicle and a driver that meet the transportation service request” here means a vehicle (vehicle available in the time frame in which the client desires to utilize the transportation service) and a driver (driver available in the time frame in which the client desires to utilize the transportation service), whose respective storage place and location are near the location of the client in the desired time frame for utilizing the transportation.

With the above-described configuration, when the transportation service request is transmitted from the client, the providing service extraction unit extracts a vehicle and a driver that meet the transportation service request based on: the vehicle providing information (at least the time information available for the transportation service and the vehicle location information in a time frame available for the transportation service) that is acquired by the vehicle information acquisition unit; the driver providing information (at least the time information available for driving for the transportation service and the driver location information in a time frame available for driving for the transportation service) that is acquired by the driver information acquisition unit; and the service request information (at least the time information desired for utilizing the transportation service and the client location information when the transportation service is utilized) that is acquired by the client information acquisition unit. Thus extracted information is transmitted to the client, the vehicle manager of the extracted vehicle, and the extracted driver. The extracted driver provides the transportation service requested from the client by driving the extracted vehicle. Thus, the client can receive the desired transportation service by the extracted vehicle and the extracted driver.

In the transportation service system, neither the vehicle nor the driver provided for the transportation service is needed to belong exclusively to the system. That is, it is possible to meet the transportation service request from the client utilizing: a vehicle not used for its original purposes (for example, delivery services for a vehicle that is registered in advance by a home delivery company); and a person (driver) who does not have any personal business. In the result, it is possible to effectively utilize resources (idle resources such as vehicles and human resources) and to continuously maintain the system.

It is preferable that the vehicle providing information includes information on a vehicle rental fee that is set by the vehicle manager of the vehicle to be provided, the driver providing information includes information on a driving fee that is set by the driver who provides driving of the vehicle, and the service request information includes information on a budget for a usage charge that is set by the client. Also, it is preferable that the providing service extraction unit is configured to extract a combination of the vehicle and the driver such that a total fee obtained by adding up the vehicle rental fee and the driving fee is within the budget for the usage charge.

With the above-described information, the client can receive the transportation service using the vehicle and the driver extracted by the providing service extraction unit with the usage charge within the budget that has been set by the client. Thus, it is possible to reduce the economic burden of the client. In the result, the client frequently utilizes the service, which contributes to continuous maintenance of the system.

Also, it is preferable that the vehicle providing information is transmitted from an information terminal owned and operated by the vehicle manager of the vehicle to be provided, the driver providing information is transmitted from an information terminal owned and operated by the registered driver, and the service request information is transmitted from an information terminal owned and operated by the client.

With the above-described configuration, the respective kinds of information are transmitted by the information terminals owned and operated respectively by the vehicle manager, the driver and the client. Thus, it is possible to easily transmit the respective kinds of information, which contributes to increase in the number of users (i.e. the vehicle managers, the registered drivers and the clients) who utilize the transportation service system, and also contributes to continuous maintenance of the system.

Also in the above-described configuration, a map display button is preferably displayed on the information terminal owned by the vehicle manager so as to display a map when the vehicle location information is input as the vehicle providing information. A map display button is preferably displayed on the information terminal owned by the driver so as to display a map when the driver location information is input as the driver providing information. Furthermore, a map display button is preferably displayed on the information terminal owned by the client so as to display a map when the client location information is input as the service request information.

When the respective kinds of location information are input, character input (for example, address input) is complicated to specify the location. In view of the foregoing, in this configuration, the respective maps are displayed by operating the map display buttons so that the location can be specified on the map to complete the input of the location information. Thus, it is possible to easily transmit the respective kinds of information, which contributes to increase in the number of users (i.e. the vehicle managers, the registered drivers and the clients) who utilize the transportation service system, and also contributes to continuous maintenance of the system.

It is preferable that a contract for the transportation service for utilizing the vehicle and the driver that are extracted by the providing service extraction unit can be cancelled after the contract has been concluded among the vehicle manager, the driver and the client, by operating any or all of the respective information terminals. It is also preferable that, when the vehicle manager or the driver cancels the contract, the providing service extraction unit extracts a vehicle and a driver as a secondary candidate in order to meet the transportation service request.

With this configuration, when the vehicle manager or the driver cancels the contract, the providing service extraction unit extracts a vehicle and a driver as the secondary candidate in order to meet the transportation service request, and then, the extracted information as the secondary candidate is transmitted from the transmission unit to the client. Thus, even when the vehicle manager or the driver cancels the contract, it is possible to realize the transportation service that meets the transportation service request of the client and to avoid the situation that the client cannot receive the transportation service, which improves user-friendliness of the system.

It is preferable that the information on the vehicle and the driver extracted by the providing service extraction unit is displayed on the information terminal owned by the client as the information that meets the transportation service request, and also that the information terminal displays a display screen prioritizing any one of the usage charge, a time desired for utilizing the service, and driving experience of the driver. Furthermore it is preferable that buttons for switching the priority are provided on the display screen of the information terminal.

In this configuration, when the display prioritizing the usage charge is selected, the multiple pieces of available service information are displayed in the order of inexpensiveness of the usage charge. When the display prioritizing the time desired for utilizing the service is selected, the multiple pieces of available service information that meet the time desired by the client for utilizing the service are displayed. When the display prioritizing the driving experience of the driver is selected, the multiple pieces of available service information are displayed in the order of abundance of the driving experience of the driver. Thus, it is possible to display the available service information on the display screen of the information terminal according to the request from the client, which improves user-friendliness to the client.

### Advantageous Effect of the Invention

In the present invention, a vehicle and a driver that meet a transportation service request are extracted based on: vehicle providing information on each of a plurality of vehicles registered in advance for providing the transportation service (at least time information and vehicle location information available for the transportation service); driver providing information on each of a plurality of drivers registered in advance for providing the transportation service (at least time information and driver location information in a time frame available for driving for the transportation service); and service request information from a client (at least time information desired for utilizing the transportation service and client location information). Thus extracted information is transmitted to the client, the vehicle manager of the extracted vehicle, and the extracted driver. In this way, it is possible to respond to the transportation service request from the client utilizing the vehicle not used and a free time of the driver, which contributes to effective utilization of resources (idle resources such as vehicles and human resources) and to continuous maintenance of the system.

### BRIEF DESCRIPTION OF THE DRAWINGS

FIG. 1 is a schematic diagram illustrating a transportation service system according to an embodiment.

FIG. 2 is a functional block diagram of a service management server.

FIG. 3 is a diagram illustrating an example of a vehicle registration screen on a smartphone.

FIG. 4 is a diagram illustrating an example of a driver registration screen on a smartphone.

FIG. 5 is a diagram illustrating an example of a client registration screen on a smartphone.

FIG. 6 is a diagram for explaining operations to extract vehicles and drivers in a providing service extraction unit.

FIG. 7 is a diagram illustrating an example of a vehicle providing information input screen on a smartphone carried by a vehicle manager.

FIG. 8 is a diagram illustrating an example of a driver providing information input screen on a smartphone carried by a registered driver.

FIG. 9 is a diagram illustrating an example of a request information input screen on a smartphone carried by a client.

FIG. 10 is a diagram illustrating an example of a service order screen on a smartphone carried by a client.

FIG. 11 is a diagram illustrating an example of a service order reception screen on a smartphone carried by a vehicle manager.

FIG. 12 is a diagram illustrating an example of a service order reception screen on a smartphone carried by a registered driver.

FIG. 13 is a diagram illustrating an example of a service order confirmation screen on a smartphone carried by a client.

FIG. 14 is a diagram illustrating an example of a service order confirmation screen on a smartphone carried by a vehicle manager.

FIG. 15 is a diagram illustrating an example of a service order confirmation screen on a smartphone carried by a registered driver.

FIG. 16 is a diagram illustrating an example of a service order screen that displays a secondary candidate after the order is cancelled.

FIG. 17 is a diagram illustrating an example of the request information input screen in a simple mode.

FIG. 18 is a diagram illustrating an example of the service order screen to which priority switch buttons are added.

### DESCRIPTION OF EMBODIMENTS

Hereinafter, an embodiment of the present invention will be described with reference to the drawings. In this embodiment, a transportation service system operates under the condition that respective registrations (i.e. user registrations) are completed with respect to the following that utilize the system: vehicles (vehicles provided to a transportation service); drivers (drivers provided to the transportation service); and clients, in order to ensure reliability of the transportation service system. However, the present invention may also be embodied as a transportation service system that clients can utilize without their user registrations.

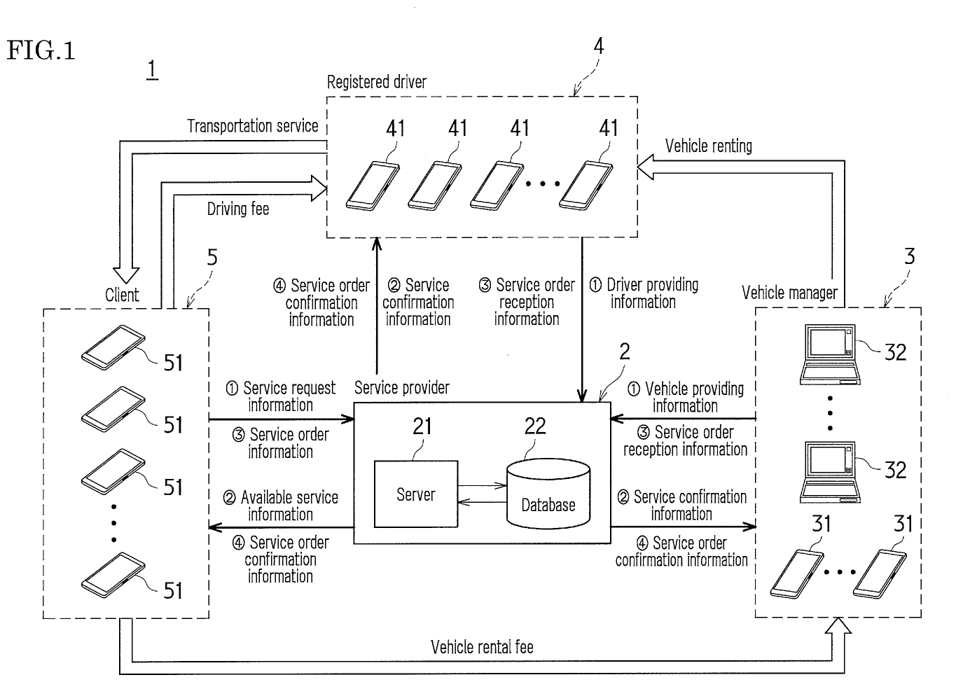

FIG. 1 is a schematic diagram illustrating a transportation service system 1 according to this embodiment. As shown in FIG. 1, the transportation service system 1 according to this embodiment includes: a service provider 2; a plurality of vehicle managers 3; a plurality of registered drivers 4; and a plurality of clients 5.

Information terminals (for example, smartphones 31, 41 and 51, and/or a personal computer 32) respectively owned by the vehicle managers 3, the registered drivers 4 and the clients 5, and a service management server 21 of the service provider 2 have a radio communication function, and are connected to a network (such as internet) via radio base stations and radio access points. Thus, it is possible to perform radio communications via the network between the service management server 21 of the service provider 2 and the information terminals 31, 32, 41 and 51 owned by the vehicle managers 3, the registered drivers 4 and the clients 5.

Various kinds of information transmitted by the vehicle managers 3, the registered drivers 4 and the clients 5 are uniformly managed by the service provider 2. Thus, according to a request for transportation service by the client 5, the service provider 2 provides information on transportation service (specifically, on dispatch of a vehicle and a driver) that can meet the request to the vehicle manager 3, the registered driver 4 and the client 5. Hereinafter, a specific configuration is described.

Vehicle Manager

The vehicle manager 3 is a business operator or a person (i.e. a corporate body or an individual) who owns a vehicle and furthermore registered the vehicle with the transportation service system 1 so as to provide the vehicle for the transportation service. Examples of the vehicle manager 3 include: a home delivery company; a car-rental company; and a restaurant, facility, organization and individual that own vehicles. That is, these vehicle managers 3 have registered their vehicles so as to provide the vehicles that are not used (i.e. the vehicles not used for their original purposes such as a delivery service of a home delivery company, renting out by a car-rental company, and a personal use by an individual owner) as the vehicles to be used for the transportation service system 1. The registered information of the vehicles is stored in a database 22 installed in the business place of the service provider 2.

When the vehicle manager 3 intends to provide the vehicle to the transportation service system 1, the vehicle manager 3 registers the vehicle in advance (user registration). In this registration, each vehicle manager 3 may register multiple vehicles. The vehicle registration information includes the vehicle number, a storage place of the vehicle, a vehicle rental fee per hour, a payment method and the like.

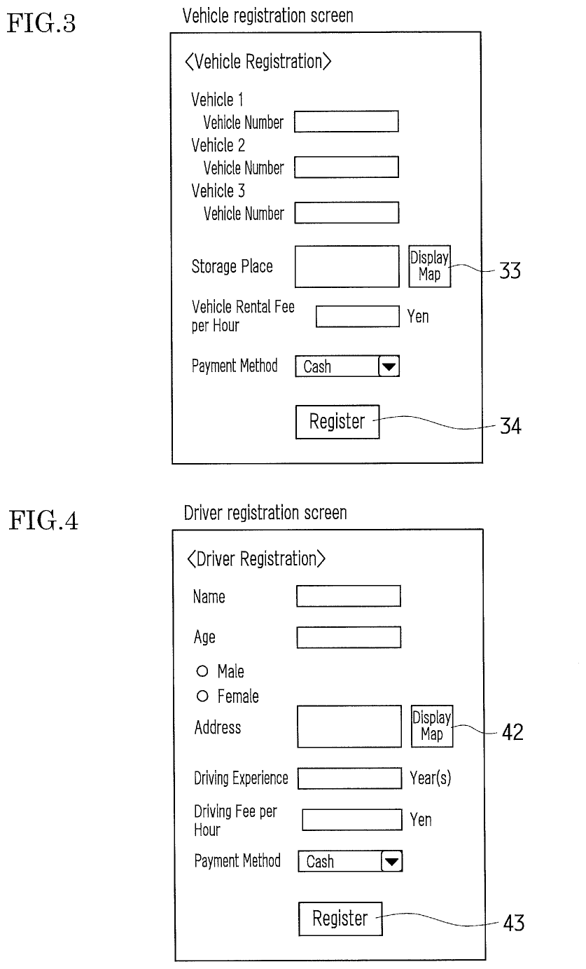

FIG. 3 is a diagram illustrating an example of a vehicle registration screen on the smartphone 31 carried by the vehicle manager 3 (when the vehicle manager 3 is a corporate body, an employer thereof). In order to display the vehicle registration screen on the smartphone 31, the vehicle manager 3 downloads, first of all, an application (so-called application for smartphone) to operate the transportation service system 1 to the smartphone 31 carried by him/her, and then taps a vehicle registration button on an initial screen of the application.

As shown in FIG. 3, the vehicle registration screen is an input screen to which are input: multiple (in FIG. 3, three) vehicle numbers; the storage place of these vehicles; a vehicle rental fee per hour; and a payment method. The vehicle number is a number on a license number plate of the vehicle. The storage place of the vehicle is a parking lot where the vehicle is stored when it is not used. On the vehicle registration screen, a map display button 33 is provided, and the vehicle manager 3 may specify the storage place of the vehicle on a map that is displayed by tapping the map display button 33. The vehicle rental fee per hour is a charge for renting the vehicle, which may be set at the discretion of the vehicle manager 3. The vehicle rental fee is not limited to the fee per hour. It may be a fee per unit mileage of the vehicle. As the payment method, various kinds of payment methods can be set, for example, cash payment, credit card payment and portable carrier settlement. For example, the payment method can be selected by a pulldown menu (a plurality of payment methods also can be selected). When the vehicle manager 3 taps the registration button 34 after inputting various kinds of information to the vehicle registration screen, the registration of the vehicles are completed.

The vehicle registration screen shown in FIG. 3 is a screen for registering multiple (three in maximal) vehicles that share the storage place, the vehicle rental fee per hour and the payment method. Therefore, when the vehicle that does not share any or all of the storage place of the vehicle, the vehicle rental fee per hour and the payment method is registered, such a registration is performed on a new vehicle registration screen by inputting various kinds of information thereof. However, it is possible to make a screen such that multiple vehicles, which do not share any or all of the storage place of the vehicle, the vehicle rental fee per hour and the payment method with one another, can be registered on the identical vehicle registration screen. Also, the registration of the vehicles may be performed by the personal computer 32.

Registered Driver

The registered driver 4 is an individual who registered with the transportation service system 1 so as to provide driving of the vehicle (driving service) for the transportation service. Examples of the driver 4 include: a healthy elderly person; a housewife; and a student. That is, the registered driver 4 is a person registered with the service provider 2 so as to provide his/her free time without any personal business as a time for driving vehicle as the transportation service. The registration information of the registered driver 4 is stored in the database 22.

When the registered driver 4 intends to provide driving to the transportation service system 1, the registered driver 4 registers himself/herself as the registered driver 4 in advance (user registration). The registration information on the registered driver 4 includes name, age, gender, address, driving experience, a driving fee per hour, a payment method and the like.

FIG. 4 is a diagram illustrating an example of the driver registration screen on the smartphone 41 carried by the registered driver 4 (more precisely, a person who is not yet a “registered driver 4” until he/she completes the registration). In order to display the driver registration screen on the smartphone 41, the registered driver 4 downloads, first of all, the application to operate the transportation service system 1 to the smartphone 41 carried by him/her, and then taps a driver registration button on the initial screen of the application.

As shown in FIG. 4, the driver registration screen is an input screen to which are input: name, age, gender, address and driving experience of the registered driver 4; a driving fee per hour; and a payment method. On the driver registration screen, a map display button 42 is provided, and the registered driver 4 may specify his/her address on a map that is displayed by tapping the map display button 42. The driving fee per hour is a compensation for the driving by the driver, which may be set at the discretion of the registered driver 4. The driving fee is not limited to the fee per hour. It may be a fee per unit mileage of drive. As the payment method, various kinds of payment methods can be set, for example, cash payment, credit card payment and portable carrier settlement. In this case also, the payment method can be selected by a pulldown menu (a plurality of payment methods can also be selected). When the credit card payment and/or the portable carrier settlement is/are set, a registered bank account is also input, so that the charged amount is transferred into this account. When the registered driver 4 taps a registration button 43 after inputting various kinds of information to the driver registration screen, the registration of the registered driver 4 is completed.

Client

The client 5 is an individual who registered with the transportation service system 1 so as to receive the transportation service. Examples of the client 5 include an elderly person who does not have an automobile or has voluntarily returned his/her driver's license. The registration information of the client 5 is stored in the database 22.

When the client 5 intends to receive the transportation service by the transportation service system 1, the client 5 registers himself/herself as the client 5 in advance (user registration). The registration information on the client 5 includes name, age, gender, address, and a payment method and the like.

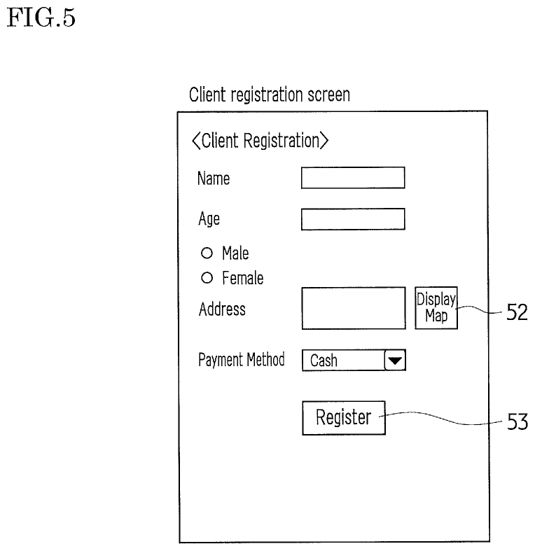

FIG. 5 is a diagram illustrating an example of the client registration screen on the smartphone 51 carried by the client 5 (more precisely, a person who is not yet a “client 5” until he/she completes the registration). In order to display the client registration screen on the smartphone 51, the client 5 downloads, first of all, the application to operate the transportation service system 1 to the smartphone 51 carried by him/her, and then taps a client registration button on the initial screen of the application.

As shown in FIG. 5, the client registration screen is an input screen to which are input: name, age, gender, and address of the client 5; and a payment method. On the client registration screen, a map display button 52 is provided, and the client 5 may specify his/her address on a map that is displayed by tapping the map display button 52. As the payment method, various kinds of payment methods can be set, for example, cash payment, credit card payment and portable carrier settlement. In this case also, the payment method can be selected by a pulldown menu (a plurality of payment methods can also be selected). When the credit card payment and/or the portable carrier settlement is/are set, a registered bank account is also input, so that the charged amount is transferred from this account (i.e. payment). When the client 5 taps a registration button 53 after inputting various kinds of information to the client registration screen, the registration of the client 5 is completed.

Service Provider

The service provider 2 is a person (a corporate body or an individual) whose transportation service according to this embodiment is authorized by the state as a business. Also, as shown in FIG. 1, the service management server 21 and the database 22 are installed in the business place of the service provider 2.

As described above, the service management server 21 transmits and receives various kinds of information (described later) between itself and the following: the smartphone 31 carried by the vehicle manager 3, the personal computer 32 installed in a business office or the like of the vehicle manager 3, the smartphone 41 carried by the registered driver 4, and the smartphone 51 carried by the client 5.

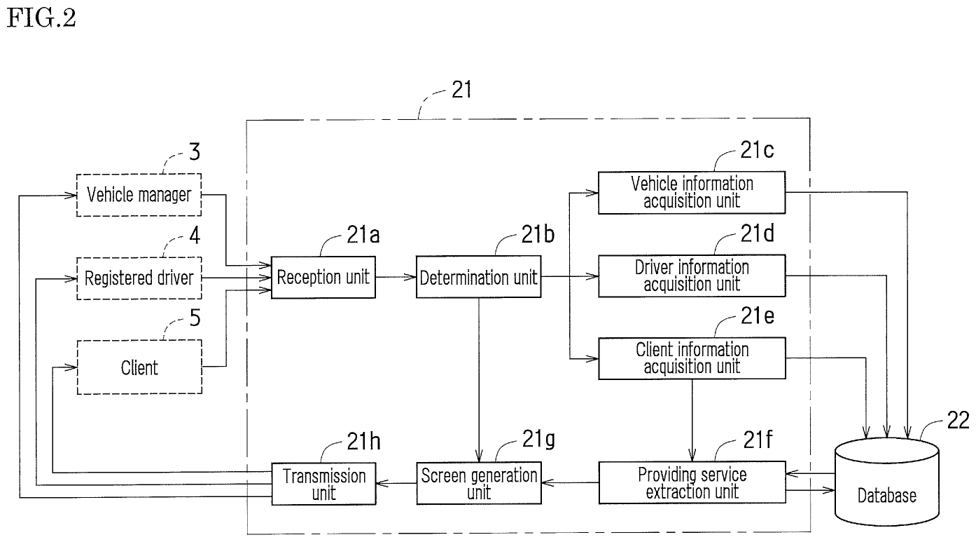

FIG. 2 is a functional block diagram of a service management server 21. As shown in FIG. 2, the service management server 21 includes: a reception unit 21a; a determination unit 21b; a vehicle information acquisition unit 21c; a driver information acquisition unit 21d; a client information acquisition unit 21e; a providing service extraction unit 21f; a screen generation unit 21g; and a transmission unit 21h.

The reception unit 21a receives information transmitted from the smartphones 31, 41 and 51 and the personal computer 32. Specifically, the reception unit 21a receives: vehicle registration information transmitted from the vehicle registration screen (see FIG. 3) on the smartphone 31 carried by the vehicle manager 3 (or vehicle registration information transmitted from the vehicle registration screen on the personal computer 32); driver registration information transmitted from the driver registration screen (see FIG. 4) on the smartphone 41 carried by the registered driver 4; and client registration information transmitted from the client registration screen (see FIG. 5) on the smartphone 51 carried by the client 5. Then the reception unit 21a transmits the above kinds of information to the determination unit 21b.

During operation of the transportation service system 1 (i.e. during operation after the respective kinds of registration information have been registered), the reception unit 21a also receives: vehicle providing information (i.e. information on vehicles that can provide the transportation service) transmitted from the smartphone 31 carried by the vehicle manager 3 and the like; driver providing information (i.e. information on a driver who can provide the transportation service) transmitted from the smartphone 41 from the registered driver 4; and service request information (i.e. information on request of the transportation service) transmitted from the smartphone 51 carried by the client 5.

The vehicle providing information includes, for example: the vehicle number; an available time frame for providing the vehicle (time information available for the transportation service in the present invention); the storage place of the vehicle (vehicle location information in the time frame available for the transportation service in the present invention); the vehicle rental fee per hour; and the payment method. The driver providing information includes, for example: an available time frame for providing the driver (time information available for driving for the transportation service in the present invention); a location of the driver (driver location information in the time frame available for driving for the transportation service in the present invention); the driving fee per hour; and the payment method. The service request information includes, for example: a desired time frame for utilizing the transportation (time information desired for utilizing the transportation service in the present invention); a desired location for utilizing the transportation (client location information when the transportation service is utilized in the present invention); a budget; and the payment method.

The reception unit 21a also transmits the vehicle providing information, the driver providing information, and the service request information to the determination unit 21b.

When the determination unit 21b receives the vehicle registration information or the vehicle providing information from the reception unit 21a, it transmits the received information to the vehicle information acquisition unit 21c. The vehicle information acquisition unit 21c stores the received information in a vehicle information storage unit in the database 22. When the determination unit 21b receives the driver registration information or the driver providing information from the reception unit 21a, it transmits the received information to the driver information acquisition unit 21d. The driver information acquisition unit 21d stores the received information in a driver information storage unit in the database 22. When the determination unit 21b receives the client registration information or the service request information from the reception unit 21a, it transmits the received information to the client information acquisition unit 21e. The client information acquisition unit 21e stores the received information in a client information storage unit in the database 22.

When the service request information is transmitted from the smartphone 51 carried by the client 5, the providing service extraction unit 21f receives the transmitted information from the client information acquisition unit 21e so as to extract vehicle providing information that meets the transportation service request in the service request information from the various kinds of vehicle providing information stored in the vehicle information storage unit in the database 22. Thus, the providing service extraction unit 21f specifies a vehicle that corresponds to the above vehicle providing information. More specifically, the providing service extraction unit 21f specifies (extracts) the vehicle of which a storage place, as the vehicle providing information, is set near (for example, within a predetermined distance from) the desired location for utilizing the transportation (in particular, the desired location for pick-up) included in the service request information, among the vehicles whose respective available time frames for providing the vehicle, as the vehicle providing information, include the desired time frame for utilizing the transportation in the service request information. When there are multiple vehicles meeting the condition, the providing service extraction unit 21f specifies (extracts) these multiple vehicles.

At this time, the providing service extraction unit 21f extracts driver providing information that meets the transportation service request in the service request information among the driver providing information stored in the driver information storage unit in the database 22. Thus, the providing service extraction unit 21f specifies a driver (registered driver 4) corresponding to the above driver providing information.

More specifically, the providing service extraction unit 21f specifies (extracts) the registered driver 4 who sets a location of the driver, as the driver providing information, near (for example, within a predetermined distance from) the desired location for utilizing the transportation (in particular, the desired location for pick-up) included in the service request information, among the registered drivers 4 each setting, as the driver providing information, the available time frame for providing the driver that includes the desired time frame for utilizing the transportation in the service request information. When there are multiple registered drivers 4 meeting the condition, the providing service extraction unit 21f specifies (extracts) these multiple registered drivers 4.

In this way, the vehicle and the driver that meet the transportation service request in the service request information are extracted.

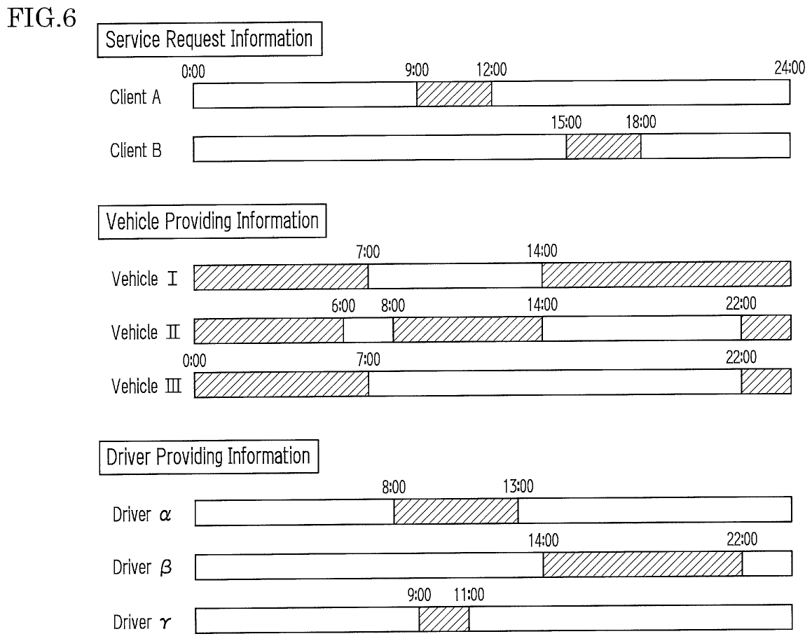

A specific example of the extraction operation of the vehicle and the driver is explained with reference to FIG. 6. FIG. 6 indicates a case in which the database 22 stores each piece of the vehicle providing information on three vehicles (vehicles I, II and III) and each piece of driver providing information on the three registered drivers 4 (drivers α, β, and γ), and furthermore in which each piece of the service request information is transmitted from two clients 5 (clients A and B). As the available time frame for providing the vehicle, the vehicle I has an available time frame between 14:00 and 07:00, the vehicle II has an available time frame between 22:00 and 06:00, and between 08:00 and 14:00, and the vehicle III has an available time frame between 22:00 and 07:00. As the available time frame for providing the driver, the driver α has an available time frame between 08:00 and 13:00, the driver β has an available time frame between 14:00 and 22:00, and the driver γ has an available time frame between 09:00 and 11:00. The desired time frame for utilizing the transportation of the client A is between 09:00 and 12:00. In this case, the providing service extraction unit 21f extracts the vehicle II and the driver α. That is, the driver α provides the transportation service to the client A, using the vehicle II in the time frame between 09:00 and 12:00. The desired time frame for utilizing the transportation of the client B is between 15:00 and 18:00. In this case, the providing service extraction unit 21f extracts the vehicle I and the driver β. That is, the driver β provides the transportation service to the client B, using the vehicle I in the time frame between 15:00 and 18:00.

The screen generation unit 21g generates the screens (images) for displaying on the information terminals 31, 32, 41 and 51. Specifically, the screen generation unit 21g generates a screen displaying the information on the vehicle and the registered driver 4 extracted by the providing service extraction unit 21f (i.e. a service order screen described later) and transmits it to the transmission unit 21h. Also, the screen generation unit 21g generates a service order reception screen and a service order confirmation screen (both described later) and transmits image information of the above to the transmission unit 21h.

The transmission unit 21h transmits, to the information terminals 31, 32, 41 and 51, image information of the respective screens generated by the screen generation unit 21g.

Operation of Transportation Service System

Here, respective display states on the smartphones 31, 41 and 51 during the specific operation of the above-described transportation service system 1 are described. During the operation of the transportation service system 1, information transmission operations as described below are performed, between the service management server 21, in response to respective operations of the smartphones 31, 41 and 51 by the vehicle manager 3, the registered driver 4 and the client 5 (see the arrows indicating the transmission and reception of the respective pieces of information in FIG. 1):

transmission operation of the “vehicle providing information” from the vehicle manager 3 to the service management server 21;

transmission operation of the “driver providing information” from the registered driver 4 to the service management server 21;

transmission operation of the “service request information” from the client 5 to the service management server 21;

transmission operation of the “available service information” from the service management server 21 to the client 5;

transmission operation of the “service order information” from the client 5 to the service management server 21;

transmission operation of the “service confirmation information” from the service management server 21 to the vehicle manager 3 and the registered driver 4;

transmission operation of the “service order reception information” from the vehicle manager 3 and the registered driver 4 to the service management server 21; and

transmission operation of the “service order confirmation information” from the service management server 21 to the vehicle manager 3, the registered driver 4 and the client 5.

Hereinafter, descriptions will be given on the transmission operations of the above kinds of information and on the respective screens on the smartphones 31, 41 and 51 when the transmission operations are performed.

(Transmission Operation of Vehicle Providing Information)

In the transmission operation of the vehicle providing information, the smartphone 31 of the vehicle manager 3 transmits, to the service management server 21, the vehicle providing information such as the vehicle number, the available time frame for providing the vehicle, the storage place of the vehicle, the vehicle rental fee per hour, and the payment method.

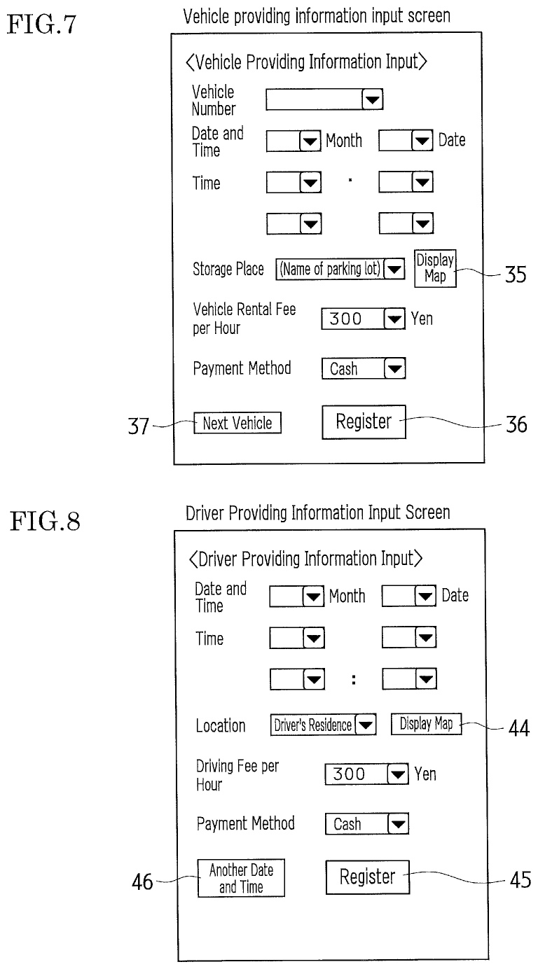

FIG. 7 is a diagram illustrating an example of a vehicle providing information input screen on the smartphone 31. This vehicle providing information input screen is displayed by tapping a vehicle providing information input button on the initial screen of the application.

As shown in FIG. 7, on the vehicle providing information input screen, respective input boxes are displayed in order to input the vehicle number, the available time frame for providing the vehicle, the storage place of the vehicle, the vehicle rental fee per hour and the payment method. By the vehicle number (i.e. a number on the license number plate of the vehicle), a particular vehicle is specified among the vehicle numbers of the plurality of vehicles registered on the vehicle registration screen (FIG. 3). That is, the list of the registered vehicles are displayed in a pulldown menu, thus a particular vehicle can be specified. Also, the available time frame for providing the vehicle can be input using the pulldown menu. As the storage place of the vehicle, the storage place of the vehicle registered on the vehicle registration screen is automatically specified as default (standard). This storage place of the vehicle can be changed, thus, in the case where the storage place of the vehicle is different depending on the day and time, the storage place of the vehicle is changed by input. For example, it is possible to change the storage place of the vehicle by tapping the map display button 35 and displaying the map. As the vehicle rental fee per hour, the vehicle rental fee registered on the vehicle registration screen is automatically specified as default. The vehicle rental fee can also be changed appropriately. As the payment method, the payment method registered on the vehicle registration screen is automatically specified as default. The payment method can also be changed appropriately using the pulldown menu.

By tapping a registration button 36 after inputting the various kinds of information to the vehicle providing information input screen, the vehicle providing information is transmitted to the service management server 21, and is further transmitted from the service management server 21 to the database 22 so that the vehicle providing information is stored in the database 22. The vehicle providing information may also be transmitted from the personal computer 32 to the service management server 21.

When inputting vehicle providing information for multiple vehicles, by tapping a display button 37 that displays “Next Vehicle” after inputting the vehicle providing information on one vehicle, the vehicle providing information input screen is newly displayed, to which vehicle providing information on another vehicle can be input. By tapping the registration button 36 after inputting the vehicle providing information for the multiple vehicles, the respective kinds of vehicle providing information on the multiple vehicles are transmitted to the service management server 21, and are further transmitted from the service management server 21 to the database 22 so that the respective kinds of vehicle providing information are stored in the database 22.

(Transmission Operation of Driver Providing Information)

In the transmission operation of the driver providing information, the smartphone 41 of the registered driver 4 transmits, to the service management server 21, the driver providing information such as the available time frame for providing the driver, the location of the driver, the driving fee per hour, and the payment method.

FIG. 8 is a diagram illustrating an example of a driver providing information input screen on the smartphone 41. This driver providing information input screen is displayed by tapping a driver providing information input button on the initial screen of the application.

As shown in FIG. 8, on the driver providing information input screen, respective input boxes are displayed in order to input the available time frame for providing the driver, the location of the driver, the driving fee per hour, and the payment method. The available time frame for providing the driver can be input using the pulldown menu. As the location of the driver, the location of the driver registered on the driver registration screen is automatically specified as default. This location of the driver can be changed, thus, in the case where the location of the registered driver 4 is different depending on the day and time, the location of the driver is changed by input. For example, it is possible to change the location of the driver by tapping a map display button 44 and displaying the map. As the driving fee per hour, the driving fee registered on the driver registration screen is automatically specified as default. The driving fee can also be changed appropriately. As the payment method, the payment method registered on the driver registration screen is automatically specified as default. The payment method can also be changed appropriately using the pulldown menu.

By tapping a registration button 45 after inputting the various kinds of information to the driver providing information input screen, the driver providing information is transmitted to the service management server 21, and is further transmitted from the service management server 21 to the database 22 so that the driver providing information is stored in the database 22.

When inputting driver providing information for multiple dates and times, by tapping a display button 46 that displays “Another Date and Time” after inputting the driver providing information on one date and time, the driver providing information input screen is newly displayed, to which driver providing information for another date and time can be input. By tapping the registration button 45 after inputting the driver providing information for the multiple dates and times, the respective kinds of driver providing information on the multiple dates and times are transmitted to the service management server 21, and are further transmitted from the service management server 21 to the database 22 so that the respective kinds of driver providing information are stored in the database 22.

(Transmission Operation of Service Request Information)

In the transmission operation of service request information, the smartphone 51 of the client 5 transmits, to the service management server 21, the service request information such as the desired time frame for utilizing the transportation, the desired location for utilizing the transportation, the budget, and the payment method.

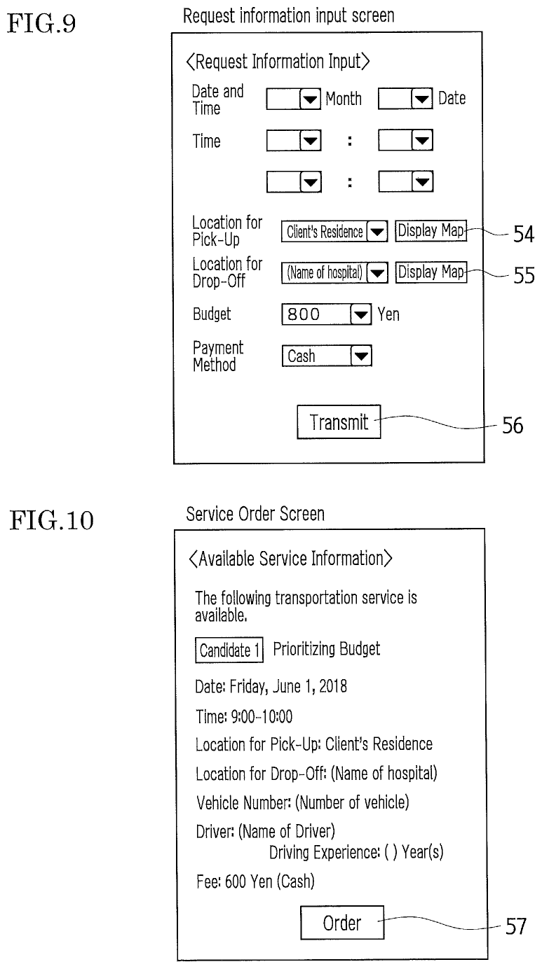

FIG. 9 is a diagram illustrating an example of a request information input screen on the smartphone 51. This request information input screen is displayed by tapping a request information input button on the initial screen of the application.

As shown in FIG. 9, on the request information input screen, respective input boxes are displayed in order to input the desired time frame for utilizing the transportation, the desired location for utilizing the transportation (locations for pick-up and for drop-off), the budget (maximum amount payable in consideration of the transportation service), and the payment method. The desired time frame for utilizing the transportation can be input using the pulldown menu. As the location for pick-up out of the desired location for utilizing the transportation, the address (for example, a residence) of the client 5 registered on the client registration screen is automatically specified as default. This location for pick-up can be changed, thus, in the case in which the location where the client 5 is to be picked up is different depending on the day and time, the location for pick-up is changed by input. For example, it is possible to change the location for pick-up by tapping a map display button 54 and displaying the map. Also, as the location for drop-off, a previous location for drop-off is extracted from the history (i.e. history of previous transportation services stored in the database 22), which is automatically specified as default. This location for drop-off can also be changed. For example, it is possible to change the location for drop-off by tapping a map display button 55 and displaying the map. The budget can be set appropriately by the client 5. As the payment method, the payment method registered on the client registration screen is automatically specified as default. The payment method can also be changed appropriately using the pulldown menu.

By tapping a transmission button 56 after inputting the various kinds of information to the request information input screen, the service request information is transmitted to the service management server 21, and is further transmitted from the service management server 21 to the database 22 so that the service request information is stored in the database 22.

(Transmission Operation of Available Service Information and Service Order Information)

In the transmission operation of available service information, the service management server 21 transmits, to the smartphone 51 of the client 5, the available service information including the vehicle and the driver extracted (specifically, extracted as service information that meets the transportation service request) by the providing service extraction unit 21f.

FIG. 10 is a diagram illustrating an example of a screen (this screen also serves as the service order screen) on the smartphone 51 when the available service information is received. This screen is displayed, almost at the same time when the smartphone 51 receives the available service information, after the transmission operation of the service request information is completed and furthermore the extraction operation of the providing service extraction unit 21f is completed.

As shown in FIG. 10, on this screen, it is possible to display multiple kinds of available service information, which are constructed by combining the vehicle and the registered driver 4 extracted by the providing service extraction unit 21f. In FIG. 10, the available service information as a candidate 1 (first candidate) is displayed. The available service information as the candidate 1 includes the minimum costs among the multiple kinds of the available service information (the multiple kinds of available service information constructed by combining the vehicle and the driver extracted by the providing service extraction unit 21f). That is, the screen prioritizing the budget is displayed. The priority is not limited to the budget. For example, it is possible to display the screen prioritizing the time (i.e. the screen on which the available service information that meets the desired time in the service request is preferentially displayed) or the screen prioritizing the driving experience of the driver (i.e. the screen on which the available service information of the driver having abundant driving experience is preferentially displayed). It is possible to display the available service information as the subordinate candidate by scrolling the screen of the smartphone 51.

On this screen are displayed the time frame for transportation (time frame in which the transportation service is carried out), the locations for pick-up and for drop-off, the vehicle number, the name of the registered driver 4, the driving experience of the registered driver 4, and the fee. The fee displayed here is a total fee obtained by adding up the vehicle rental fee (fee obtained by multiplying the vehicle rental fee per hour specified in the vehicle providing information by the time taken for the transportation service) and the driving fee (fee obtained by multiplying the driving fee per hour specified in the driver providing information by the time taken for the transportation service).

When the client 5 accepts the transportation service to be provided, he/she taps an order button 57. By tapping the order button 57, the service order information is transmitted from the smartphone 51 to the service management server 21.

(Transmission Operation of Service Confirmation Information and Service Order Reception Information)

In the transmission operation of service confirmation information, in response to the transmission of the service order information to the service management server 21, the service management server 21 transmits the service confirmation information to the smartphone 31 of the vehicle manager 3 and the smartphone 41 of the registered driver 4.

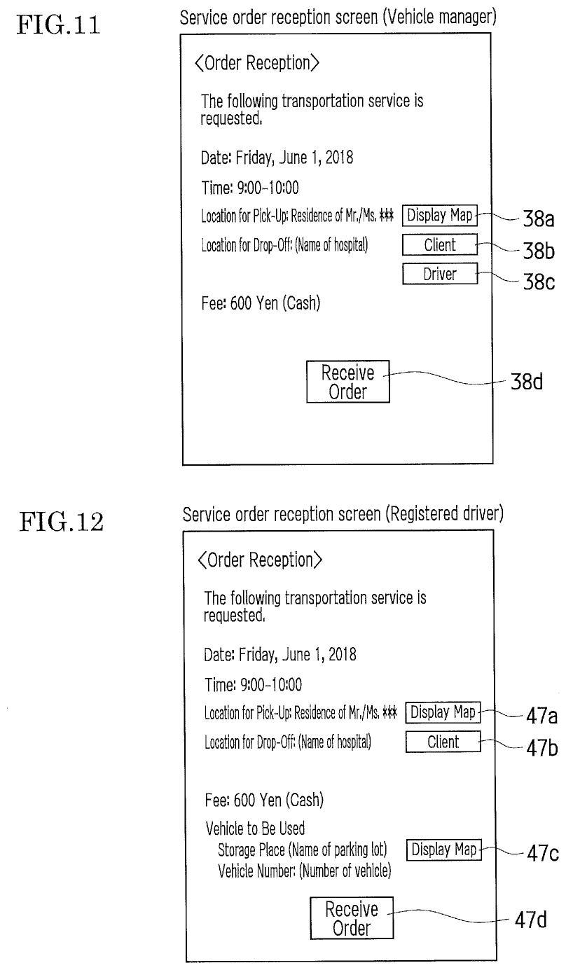

FIG. 11 is a diagram illustrating an example of a screen (this screen also serves as the service order reception screen) on the smartphone 31 when the service confirmation information is received. FIG. 12 is a diagram illustrating an example of a screen (this screen also serves as the service order reception screen) on the smartphone 41 when the service confirmation information is received.

As shown in FIGS. 11 and 12, on these screens is displayed the service ordered by the client 5 on the service order screen in FIG. 10, which is constructed by combining the vehicle and the driver extracted by the providing service extraction unit 21f.

On the respective screens shown in FIGS. 11 and 12 are displayed the time frame for transportation (time frame in which the transportation service is carried out), the locations for pick-up and for drop-off, and the fee. Also, map display buttons 38a and 47a, and client information display buttons 38b and 47b are respectively displayed. When the map display buttons 38a and 47a are tapped, a vicinity map of the location for picking up the client 5 (for example, his/her residence) is displayed. When the client information display buttons 38b and 47b are tapped, the information on the client 5 registered on the client registration screen (FIG. 5) is displayed. Also, on the screen shown in FIG. 11, a driver information display button 38c is displayed. When the driver information display button 38c is tapped, the information on the registered driver 4 registered on the driver registration screen (FIG. 4) is displayed.

Also on the screen shown in FIG.12, the storage place of the vehicle and the vehicle number are displayed as the information on the vehicle used for the transportation service. When a map display button 47c is tapped, a vicinity map of the storage place of the vehicle is displayed. In this way, the registered driver 4 confirms the vehicle to be used and the storage place thereof.

When the vehicle manager 3 takes the order of the transportation service shown in FIG. 11, he/she taps an order reception button 38d. By tapping the order reception button 38d, the service order reception information is transmitted from the smartphone 31 to the service management server 21. Similarly to the above, when the registered driver 4 takes the order of the transportation service shown in FIG. 12, he/she taps an order reception button 47d. By tapping the order reception button 47d, the service order reception information is transmitted from the smartphone 41 to the service management server 21.

(Transmission Operation of Service Order Confirmation Information)

In the transmission operation of service order confirmation information, in response to the transmission of the respective kinds of service order reception information to the service management server 21, the service management server 21 transmits the service order confirmation information to the smartphone 31 of the vehicle manager 3, the smartphone 41 of the registered driver 4, and the smartphone 51 of the client 5.

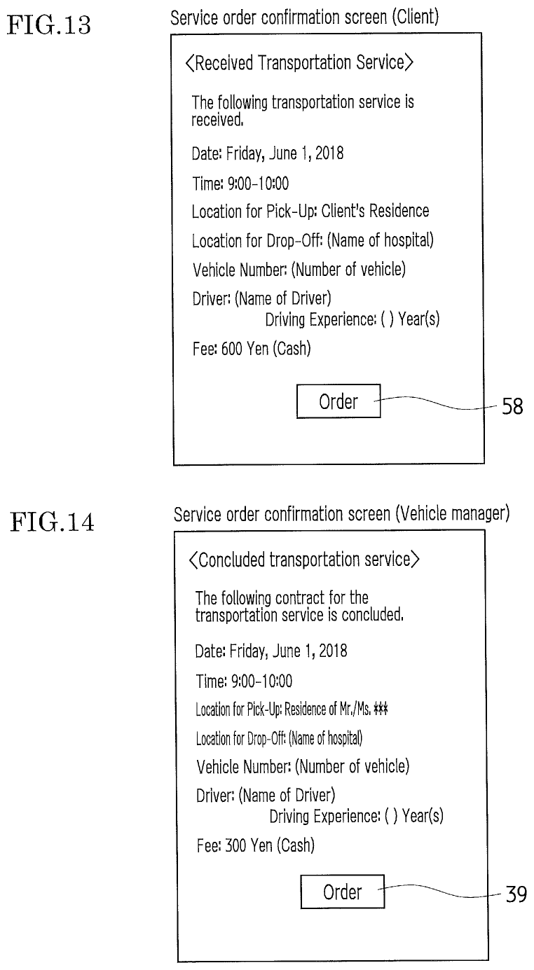

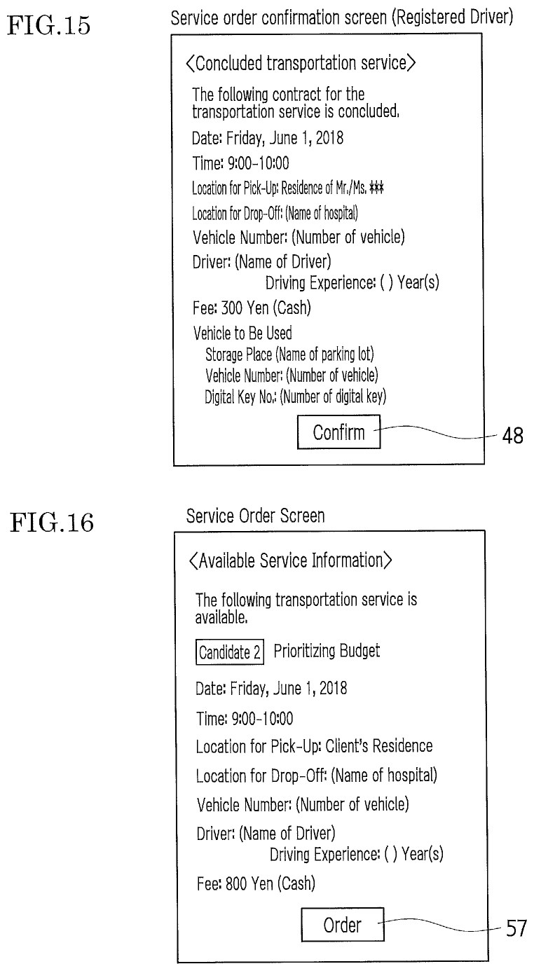

FIG. 13 is a diagram illustrating an example of a service order confirmation screen on the smartphone 51 when the service order confirmation information is received. FIG. 14 is a diagram illustrating an example of a service order confirmation screen on the smartphone 31 when the service order confirmation information is received. FIG. 15 is a diagram illustrating an example of a service order confirmation screen on the smartphone 41 when the service order confirmation information is received.

As shown in FIGS. 13 to 15, on the respective service order confirmation screens is displayed a service to which the vehicle manager 3, the registered driver 4 and the client 5 agree.

On the respective service order confirmation screens are displayed the time frame for the transportation (time frame in which the transportation service is carried out), the locations for pick-up and for drop-off, the vehicle number, the name of the registered driver 4, and the fee. Also, on the screen shown in FIG. 15, a digital key number is displayed so that the registered driver 4 can obtain an ignition key of the vehicle used for the transportation service. Specifically, the registered driver 4 can obtain the ignition key by unlocking, using the digital key, a key box provided in the vehicle. Alternatively, an authentication screen (for example, a screen constituted of a barcode) for obtaining the ignition key may be displayed on the service order confirmation screen of the smartphone 41 of the registered driver 4, so that the registered driver 4 indicates the authentication screen for the ignition key to the vehicle manager 3 (i.e. the vehicle manager 3 scans information on the barcode) and obtains the ignition key.

When all of the vehicle manager 3, the registered driver 4 and the client 5 tap, respectively, confirmation buttons 39, 48 and 58 after they confirm respectively the service to be provided, the contract for the transportation service is concluded, and the information of the contract is stored in the database 22.

When the contract for the transportation service is concluded as described above, the registered driver 4 drives the vehicle for providing the transportation service in accordance with the contract, and thus provides the transportation service requested from the client 5. In other words, the client 5 receives the desired transportation service by the vehicle and the registered driver 4 extracted in accordance with the contract for the transportation service.

The client 5 who has received the transportation service pays the fee (compensation) to the vehicle manager 3 and the registered driver 4. In this case, when the credit card payment or the portable carrier settlement is selected, the fee is automatically transferred to the respective bank accounts registered by the vehicle manager 3 and the registered driver 4. When the cash payment is selected, the client 5 pays the total fee to the registered driver 4, and the registered driver 4 pays the vehicle rental fee, from the received total fee, to the vehicle manager 3 when the registered driver 4 returns the vehicle to the vehicle manager 3.

As described above, in the transportation service system 1 in this embodiment, neither the vehicle nor the registered driver 4 provided for the transportation service is needed to belong exclusively to the system. That is, it is possible to meet the transportation service request of the client 5 utilizing: a vehicle not used for its original purposes (for example, delivery services for a vehicle that is registered in advance by a home delivery company); and a person (i.e. registered driver 4) who does not have any personal business. As a result, it is possible to effectively utilize resources (idle resources such as vehicles and human resources) and to continuously maintain the system.

Furthermore, since the resources (idle resources such as vehicles and human resources) are effectively utilized, it is possible to reduce the usage charge (i.e. the fee to be paid by the client 5). For example, the usage charge can be lower than a taxi fare, which reduces the burden of the client 5. Thus, it is possible to ensure the number of users who utilize the transportation service system 1, which also contributes to continuous maintenance of the system.

Also in this embodiment, the client 5 can receive the transportation service using the vehicle and the registered driver 4 extracted by the providing service extraction unit 21f with the usage charge within the budget that has been set by the client 5 (when the client 5 orders the service from the screen prioritizing the budget). Thus, it is possible to reduce the economic burden of the client 5.

Also in this embodiment, the map is displayed by tapping the map display button, and the respective kinds of location information can be input by specifying the location on the map. Thus, it is possible to simplify the input operations.

Other Functions of Transportation Service System

The above description was given on the basic functions of the transportation service system 1. Hereinafter, other functions added to the transportation service system 1 will be described. Each of the functions described below is not essential in the transportation service system 1. However, the transportation service system 1 preferably has these functions in terms of improvement in user-friendliness of the system.

(Contract Cancellation Function)

The transportation service system 1 has a contract cancellation function. This function is to cancel the contract for the transportation service before execution in the case in which any of the vehicle manager 3, the registered driver 4 and the client 5 cannot execute the contract after the contract has been concluded.

The smartphones 31, 41 and 51 can respectively display a contract confirmation screen. On the contract confirmation screen, the information similar to the information displayed on the service order confirmation screen (FIGS. 13 to 15) is displayed. Furthermore, on the contract confirmation screen, a contract cancellation button is displayed. By tapping the contract cancellation button, the contract for the transportation service is cancelled.

When the client 5 cancels the contract from the contract confirmation screen of the smartphone 51, the contract cancellation information is transmitted from the service management server 21 to the smartphone 31 of the vehicle manager 3 and the smartphone 41 of the registered driver 4. Thus, the vehicle manager 3 and the registered driver 4 recognize the cancellation of the contract for the transportation service.

Also, when the vehicle manager 3 cancels the contract from the contract confirmation screen of the smartphone 31 or when the registered driver 4 cancels the contract from the contract confirmation screen of the smartphone 41, the contract cancellation information is transmitted from the service management server 21 to the smartphone 51 of the client 5. Thus, the client 5 recognizes the cancellation of the contract for the transportation service. In this case, on the smartphone 51 of the client 5 is displayed the service order screen with the available service information as a secondary candidate (candidate 2), as shown in FIG. 16. In the case in which the client 5 accepts the displayed transportation service (transportation service as the secondary candidate), he/she taps the order button 57 on the screen. By tapping the order button 57, the service order information is transmitted from the smartphone 51 to the service management server 21. Since the operations after the service order information is transmitted is the same as the operations described above, the description is omitted here.

With this configuration, even when the vehicle manager 3 or the registered driver 4 discharges (cancels) the contract, it is possible to realize the transportation service that meets the transportation service request of the client 5 and to avoid the situation that the client 5 cannot receive the transportation service, which improves user-friendliness of the system.

When the client 5 cancels the contract from the contract confirmation screen of the smartphone 51, the system may allow the client 5 to cancel only the registered driver 4. That is, the client 5 may change the request so as to only rent the vehicle. In this case, the client 5 requests a driver of the vehicle to a third party without using the system.

(Simple Mode Display Function)

In the transportation service system 1, the display in detailed mode and the display in simple mode can be switched on the request information input screen.

In the display in detailed mode, the input screen is displayed with a number of input boxes that require relatively detailed information such as the desired time frame for utilizing the transportation, the desired location for utilizing the transportation, the budget and the payment method, as shown in FIG. 9.

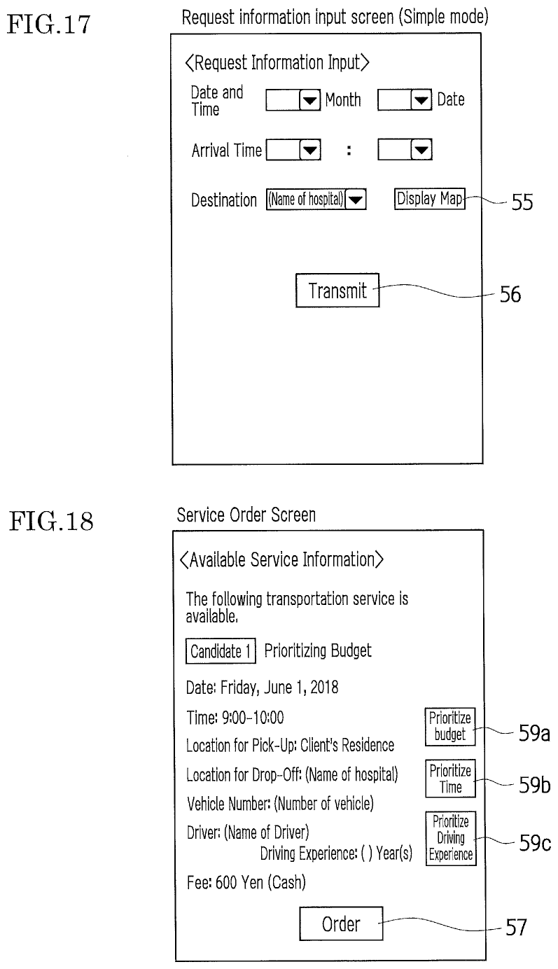

In contrast, in the display in simple mode, the input screen is displayed with the input boxes that require only the destination and the arrival date and time at the destination, as shown in FIG. 17.

When the service management server 21 receives the service request information from the display in simple mode, the service management server 21 calculates the departure time from the residence of the client 5 so as to arrive the destination at the desired arrival date and time based on the distance between the residence of the client 5 and the destination. Thus, the service management server 21 transmits, to the smartphone 51 of the client 5, information on the time for picking up the client 5 at the residence. Then, the service order screen as shown in FIG. 10 is displayed on the smartphone 51. According to the order placed from the smartphone 51, the service order reception screens shown in FIGS. 11 and 12 are respectively displayed on the smartphone 31 of the vehicle manager 3 and the smartphone 41 of the registered driver 4.

Since the display in simple mode can be used, it is possible to simplify the input operations for service request by operating the smartphone 51, which provides the user-friendly transportation service system 1 especially to the elderly people.

(Priority Switching Function)

This function is to change the display order of the available service information on the service order screen (FIG. 10) according to request of the client 5.

Specifically, this function is to select and switch the display among the display prioritizing the budget, the display prioritizing the time, and the display prioritizing the driving experience.

FIG. 18 is a diagram illustrating the service order screen in the above-described case. On the service order screen shown in FIG. 18, a budget priority button 59a, a time priority button 59b and a driving experience priority button 59c are displayed.

When the budget priority button 59a is tapped and the display prioritizing the budget is selected, the available service information is displayed in the order of inexpensiveness of the fee out of the various kinds of available service information extracted. That is, if there is a certain time deviation between the desired date and time for the transportation service and the available date and time for the transportation service, or if the registered driver 4 has relatively poor driving experience, such a mismatching is allowed so as to preferentially display the available service information prioritizing the budget.

Also, when the time priority button 59b is tapped and the display prioritizing the time is selected, the available service information that meets the desired date and time for the transportation service is displayed out of the various kinds of available service information extracted. That is, if the fee exceeds the budget, or if the registered driver 4 has relatively poor driving experience, such a mismatching is allowed so as to preferentially display the available service information prioritizing the time.

Also, when the driving experience priority button 59c is tapped and the display prioritizing the driving experience is selected, the available service information is displayed in the order of abundance of the driving experience of the driver 4 out of the various kinds of available service information extracted. That is, if there is a certain time deviation between the desired date and time for the transportation service and the available date and time for the transportation service, or if the fee exceeds the budget, such a mismatching is allowed so as to preferentially display the available service information prioritizing the driving experience.

### Other Embodiments

The present invention is not limited to the above embodiment and may be embodied in various other forms without departing from the meaning and range of equivalency of the claims.

For example, in the above embodiment, the vehicle manager 3 and the registered driver 4 are different persons. However, the present invention is not limited thereto. The vehicle manager 3 may be the same person as the registered driver 4. More specifically, an individual as an owner of a vehicle may register him/herself as the vehicle manager 3 and the registered driver 4 so as to provide the transportation service by driving his/her vehicle. For example, in depopulation areas (i.e. areas where there is no public transportation) in Japan, an individual is authorized to provide the transportation service by driving his/her vehicle.

Also, in the above embodiment, when the service request information is received in the state in which the vehicle providing information and the driver providing information are stored in the database 22 of the service provider 2, the providing service extraction unit 21f extracts the vehicle and the registered driver 4 (that is, suggestion of available service information constructed by combining the vehicle and the registered driver 4). However, the present invention is not limited thereto. The service provider 2 may contact the vehicle managers 3 via the smartphones 31 and the registered drivers 4 via the smartphones 41 after the service request information is received. Thus, the provider 2 receives vehicle providing information from the smartphones 31 of the vehicle managers 3 and driver providing information from the smartphones 41 of the registered drivers 4, and then extracts the vehicle and the registered driver 4 that meet the transportation service request.

Also, in the present invention, the location for drop-off is not essential as the service request information that is input to the request information input screen (FIG. 9). In this way, the system may be utilized in such a manner that the client 5 tells orally the destination to the registered driver 4 after the ride.

Also, in the above embodiment, the location information is manually input. However, the present invention is not limited thereto. When the current location is input as the location information, such location information may be input using the GPS (Global Positioning System) of the smartphones 31, 41 and 51.

### INDUSTRIAL APPLICABILITY

The present invention is suitably applied to a transportation service system for providing a vehicle and a driver according to a transportation service request from a client.

### REFERENCE SIGNS LIST

1 Transportation service system

2 Service provider

21 Service management server

21c Vehicle information acquisition unit

21d Driver information acquisition unit

21e Client information acquisition unit

21f Providing service extraction unit

21h Transmission unit

3 Vehicle manager

4 Registered driver

5 Client

31, 41, 51 Smartphone (information terminal)

32 Personal computer (information terminal)

59a Budget priority button

59b Time priority button

59c Driving experience priority button

What is claimed is:

1. A transportation service system for providing a vehicle and a driver according to a transportation service request from a client, comprising:
a vehicle information acquisition unit configured to acquire, at least, time information available for the transportation service and vehicle location information in a time frame available for the transportation service, both as vehicle providing information on each of a plurality of vehicles registered in advance for providing the transportation service;
a driver information acquisition unit configured to acquire, at least, time information available for driving for the transportation service and driver location information in a time frame available for driving for the transportation service, both as driver providing information on each of a plurality of drivers registered in advance for providing the transportation service;
a client information acquisition unit configured to acquire, at least, time information desired for utilizing the transportation service and client location information when the transportation service is utilized, both as service request information from the client;
a providing service extraction unit configured to extract a vehicle and a driver that meet the transportation service request in the service request information based on the respective kinds of information acquired by the vehicle information acquisition unit, the driver information acquisition unit and the client information acquisition unit; and
a transmission unit configured to transmit information extracted by the providing service extraction unit to: the client; a vehicle manager of the extracted vehicle; and the extracted driver.

2. The transportation service system according to claim 1, wherein
the vehicle providing information includes information on a vehicle rental fee that is set by the vehicle manager of the vehicle to be provided, the driver providing information includes information on a driving fee that is set by the driver who provides driving of the vehicle, and the service request information includes information on a budget for a usage charge that is set by the client, and
the providing service extraction unit is configured to extract a combination of the vehicle and the driver such that a total fee obtained by adding up the vehicle rental fee and the driving fee is within the budget for the usage charge.

3. The transportation service system according to claim 1, wherein
the vehicle providing information is transmitted from an information terminal owned and operated by the vehicle manager of the vehicle to be provided,
the driver providing information is transmitted from an information terminal owned and operated by the registered driver, and
the service request information is transmitted from an information terminal owned and operated by the client.

4. The transportation service system according to claim 3, wherein
a map display button is displayed on the information terminal owned by the vehicle manager so as to display a map when the vehicle location information is input as the vehicle providing information,
a map display button is displayed on the information terminal owned by the driver so as to display a map when the driver location information is input as the driver providing information, and
a map display button is displayed on the information terminal owned by the client so as to display a map when the client location information is input as the service request information.

5. The transportation service system according to claim 3, wherein
a contract for the transportation service for utilizing the vehicle and the driver that are extracted by the providing service extraction unit is capable of being cancelled after the contract has been concluded among the vehicle manager, the driver and the client, by operating any or all of the respective information terminals, and
when the vehicle manager or the driver cancels the contract, the providing service extraction unit extracts a vehicle and a driver as a secondary candidate in order to meet the transportation service request.

6. The transportation service system according to claim 3, wherein
the information on the vehicle and the driver that is extracted by the providing service extraction unit is displayed on the information terminal owned by the client as the information that meets the transportation service request,
the information terminal displays a display screen prioritizing any one of the usage charge, a time desired for utilizing the service, and driving experience of the driver, and
buttons for switching the priority are provided on the display screen of the information terminal.
